(19) United States
(12) Patent Application Publication
(10) Pub. No.: US 2021/0001780 A1
(43) Pub. Date: Jan. 7, 2021

(54) BREAKAWAY ARM OF AN ACCESSORY MOUNT

(71) Applicant: Innovative Product Solutions, LLC, Ogden, UT (US)

(72) Inventors: Jeffrey D. Hancock, Uintah, UT (US); Christopher N. Schenck, Uintah, UT (US)

(21) Appl. No.: 16/503,329

(22) Filed: Jul. 3, 2019

(51) Int. Cl. B60R 11/00; F16M 11/04; F16M 11/20

(52) U.S. Cl. CPC B60R 11/00; B60R 2011/0059; F16M 11/2014; F16M 11/04

(57) ABSTRACT

An arm subassembly may include a ring with inner and first surfaces. The arm subassembly may include a first interlock element on the first surface. The arm subassembly may include a first tooth set on the inner surface. The arm subassembly may include a first block with a structure. The arm subassembly may include a second tooth set on a surface of the structure. The second tooth set and the structure may be configured to receive the ring such that the first tooth set interfaces with the second tooth set. The second tooth set and the structure may retain a position of the ring relative to the first block. The arm subassembly may include a second block with a second surface that includes a second interlock element. The second surface may be configured to contact the first surface such that the first interlock element interfaces with the second interlock element.

### FIELD

Embodiments of the present disclosure are generally directed to accessory mounts, and in particular, to breakaway arms of vehicle accessory mount assemblies.

### BACKGROUND

Accessories may be attached to a recreational vehicle. The accessories may enable a user to customize or adapt the recreational vehicle to a particular purpose. For example, some conventional systems implement a bracket or bracket system that may be used to attach a camera, a rangefinder, or a light relative to a structure of the recreational vehicle.

Placement of the accessories on the recreational vehicle may subject the accessory to damage. For instance, the accessories may extend from a side of the recreational vehicle, which may subject the accessories to damage from structures and environmental features that pass next to the recreational vehicle during use.

Conventional brackets may be attached to the recreational vehicle by screws, rivets, and other types of fasteners. These brackets may retain the accessories in a static or single position. Accordingly, these brackets may heighten risks of damage to the accessories. Some other conventional brackets might include a breakaway feature. The breakaway feature may reduce damage by enabling an impact to the accessory to result in a positional change instead of a mere collision. These conventional brackets, however, may limit an ability to place the accessory in a particular position relative to the recreational vehicle and may involve significant time determining the position of the accessory.

The subject matter disclosed and claimed in the present disclosure is not limited to embodiments that solve any disadvantages or that operate only in particular environments. Rather, this background is provided to illustrate one example technology area where some embodiments described in the present disclosure may be practiced.

### SUMMARY

An aspect of an embodiment of the invention includes a breakaway arm subassembly of a vehicle accessory mount assembly. The arm subassembly may include a ring, a first mechanical interlock element, a first tooth set, a first block, a second tooth set, a second block, and a second mechanical interlock element. The ring may include an inner circumferential surface and a first radial surface. The first mechanical interlock element may be included on the first radial surface of the ring. The first tooth set may be disposed on the inner circumferential surface of the ring. The first block may include a cylindrical structure extending in a first direction. The second tooth set may be disposed on an outer surface of the cylindrical structure. The second tooth set and the cylindrical structure may be sized and configured to receive the ring such that the first tooth set mechanically interfaces with the second tooth set to retain a rotational position of the ring relative to the first block. The second block may include a second radial surface. The second mechanical interlock element may be disposed on the second radial surface. The second radial surface may be sized and configured to contact the first radial surface such that the first mechanical interlock element mechanically interfaces with the second mechanical interlock element.

Another aspect of an embodiment includes an arm subassembly of a vehicle accessory mount assembly. The arm subassembly may include multiple components such as a first block, a second block, a ring, a fastener assembly, and a spring. The first block may include a first end having a vehicle interface and a second end having a cylindrical structure that includes a first mechanical interlock element. The second block including a first end having an accessory interface and a second end having a second mechanical interlock element. The ring may include a third mechanical interlock element and a fourth mechanical interlock element. The first mechanical interlock element may be configured to mechanically interface with the third mechanical interlock element to enable the ring to be positioned on the cylindrical structure and to substantially prevent rotation of the ring relative to the cylindrical structure. The second mechanical interlock element may be configured to mechanically interface with the fourth mechanical interlock element to enable rotation of the second block a particular distance relative to the ring responsive to application of a force to the second block of a particular magnitude.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1A illustrates a vehicle accessory mount assembly including an exemplary arm subassembly;

FIG. 1B illustrates an exploded view of the vehicle accessory mount assembly of FIG. 1A;

FIG. 2A illustrates an exemplary first block that may be implemented in the arm subassembly of FIGS. 1A and 1B;

FIG. 2B illustrates another view of the first block of FIG. 2A;

FIG. 3A illustrates an exemplary ring that may be implemented in the arm subassembly of FIGS. 1A and 1B;

FIG. 3B illustrates another view of the ring of FIG. 3A;

FIG. 4A illustrates an exemplary second block that may be implemented in the arm subassembly of FIGS. 1A and 1B;

FIG. 4B illustrates another view of the second block of FIG. 4A;

FIG. 4C illustrates a sectional view of the second block of FIG. 4A;

FIG. 5 illustrates a cross sectional view of a portion of the arm subassembly of FIGS. 1A and 1B;

FIG. 6A illustrates an exemplary mechanical interface of the first block and the ring of FIGS. 2A and 3A, respectively;

FIG. 6B illustrates another exemplary mechanical interface of the first block and the ring of FIGS. 2A and 3A, respectively;

FIG. 7A illustrates the arm subassembly of FIGS. 1A and 1B in an initial position;

FIG. 7B illustrates the arm subassembly of FIGS. 1A and 1B in a second position;

FIG. 8A illustrates an additional vehicle accessory mount assembly including an additional exemplary arm subassembly;

FIG. 8B illustrates an exploded view of the additional vehicle accessory mount assembly of FIG. 8A; and

FIG. 9 illustrates a cross sectional view of an enlarged portion of the additional vehicle accessory mount assembly and the exemplary arm subassembly of FIG. 8A,

all according to at least one embodiment described in the present disclosure.

### DESCRIPTION OF EMBODIMENTS

The present disclosure is directed towards a vehicle accessory mount assembly that may be used to attach one or more accessories to a structure such as a vehicle. The present disclosure, however, is not limited to a vehicle accessory mount assembly that may be used to attach one or more accessories to a structure such as a vehicle. It will be understood that, in light of the present disclosure, the vehicle accessory mount assembly disclosed in the present disclosure can be successfully used in connection with other types of structures and these structures may be movable or immovable.

Additionally, to assist in the description of the vehicle accessory mount assembly, words such as top, bottom, front, rear, right and left are used to describe the accompanying figures. It will be appreciated, however, that the vehicle accessory mount assembly can be located in a variety of desired positions, including various angles, sideways and even upside down. Further, the drawings may show the vehicle accessory mount assembly, along with various components, attachments, and accessories, to scale. The drawings, however, are not necessarily to scale and the vehicle accessory mount assembly, components, attachments, and/or accessories may have other suitable shapes, sizes, configurations, and arrangements. A detailed description of the vehicle accessory mount assembly now follows.

Advantageously, the vehicle accessory mount assembly may allow one or more accessories to be attached to a structure such as a vehicle. After reviewing this disclosure, one skilled in the art may appreciate that a manner in which a vehicle accessory mount assembly is attached and/or attaches an accessory to a vehicle may affect one or more aspects such as functionality, versatility, aesthetics, convenience, safety, etc. Other example factors or example scenarios in which the vehicle accessory mount assembly may have an effect may include after-market parts of a vehicle, capability of attaching the vehicle accessory mount assembly to different types, sizes, and configurations of vehicles, attaching a variety of different accessories to the vehicle, etc.

In some embodiments, the vehicle accessory mount assembly may include a breakaway arm subassembly. The breakaway arm subassembly may be configured to retain a second block (or an accessory) relative to the vehicle or a first block at two or more particular rotational positions. Additionally, the breakaway arm subassembly may include a ring configured to mechanically interface with one or more interlock elements of the first block and the second block. The ring may be configured to prevent rotation of the ring relative to the first block and to retain the second block at rotational positions relative to the first block. In some embodiments, the breakaway arm subassembly may retain the second block at an initial position until the second block, or the accessory, is acted upon by a first force. For instance, a tree or another rigid item may strike the second block, or the accessory, and apply the first force. Responsive to the first force, the second block may rotate relative to the first block a particular rotational distance to a secondary position. The breakaway arm subassembly may retain the second block at the secondary position until a second force is applied to the second block or the accessory. Responsive to the second force, the second block may rotate relative to the first block from the secondary position to the initial position.

These and other embodiments of the present disclosure will be explained with reference to the accompanying figures. In the figures, features with like numbers indicate like structure and function unless described otherwise.

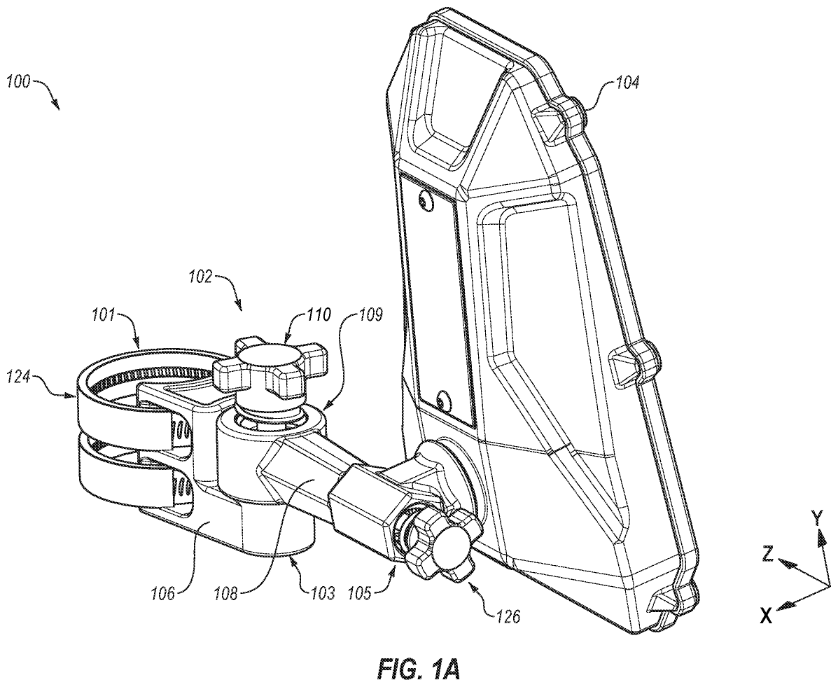

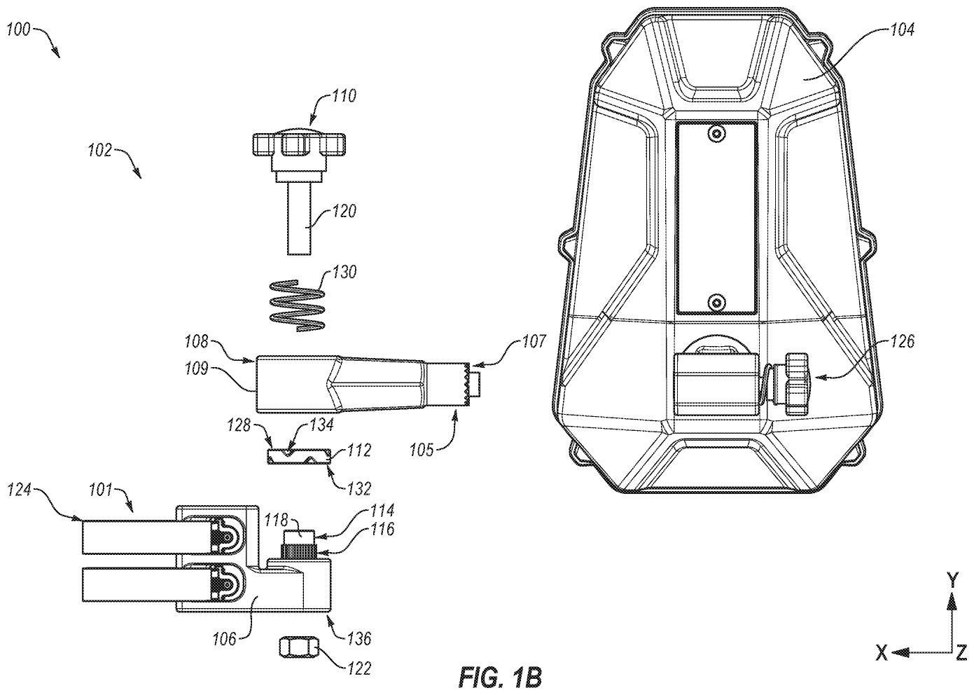

FIGS. 1A and 1B illustrate an exemplary vehicle accessory mount assembly 100. FIG. 1A is a perspective view of the vehicle accessory mount assembly 100. FIG. 1B is an exploded view of the vehicle accessory mount assembly 100. The vehicle accessory mount assembly 100 includes a breakaway arm subassembly 102 (hereinafter, arm subassembly 102). The arm subassembly 102 may enable a user to place an accessory 104 (shown in FIGS. 1A and 1B as a mirror) at a particular rotational position relative to a vehicle (not shown). Following an impact or event, the accessory 104 may be unexpectedly repositioned through a change in a rotational position of the arm subassembly 102. The arm subassembly 102 enables a user to relatively easily reposition the accessory to the particular rotational position.

For instance, the arm subassembly 102 may include a first block 106 that is configured to be attached to the vehicle via a vehicle interface device 124. The first block 106 may be placed at a rotational position relative to the vehicle. In addition, the arm subassembly 102 may include a second block 108 that is configured to be attached to the first block 106 and to the accessory 104. The second block 108 may be placed at an initial position (e.g., a particular rotational position) relative to the first block 106. The initial position of the first block orients or places the accessory 104 at the particular rotational position. The second block 108 may be retained at the initial position until the second block 108 or the accessory 104 is acted upon by a first force (e.g., via an impact with an environment feature). For instance, the accessory 104 may be positioned to extend substantially normal to the vehicle. As a user operates the vehicle, the accessory 104 may hit a tree or another environmental feature. Responsive to the first force being applied by the tree, the second block 108 and the accessory 104 may rotate a particular rotational distance relative to the first block 106 to a secondary position. The vehicle accessory mount assembly 100 may enable a re-positioning of the second block 108 from the secondary position to the initial position.

Referring to FIG. 1B, the vehicle accessory mount assembly 100 may include the accessory 104 and the arm subassembly 102. In FIGS. 1A and 1B, the accessory 104 includes a mirror and a mirror housing that is attached to the arm subassembly 102. In other embodiments, the accessory 104 may include and/or relate to any part or component that may be added, attached, or connected to a vehicle; may replace a part, a portion, or a product of a vehicle; may be related to a function or design of the vehicle; may be related to safety; may be related to an environment of the vehicle; and/or may be related to wants/needs of a user. Examples of accessories may include video recording equipment (e.g., camera, GoPro®, camcorder, mobile device, etc.), safety equipment (e.g., fire extinguisher, medical kit, emergency kit, flag, etc.), lighting equipment (e.g., light bar, spotlight, signal light, emergency light, aesthetic light, accent light, etc.), navigation equipment (e.g., GPS device, golf course play-tracking device, etc.), sound equipment (e.g., portable speaker, BlueTooth® speaker, megaphone, etc.), carrying/transportation equipment (e.g., gun hold/rack/case, bow hold/rack/case, pack hold, gear hold, meat hold, ski/wakeboard rack, cargo hold, etc.), hunting equipment (e.g., rangefinder, binoculars, spotting scope, ammunition case, shooting sticks, etc.), and the like, including any mounts to receive, support, or hold the foregoing.

The arm subassembly 102 may be configured to retain the accessory 104 relative to the vehicle at two or more particular rotational positions and may enable a breakaway feature of the vehicle accessory mount assembly 100. With reference to FIG. 1B, the arm subassembly 102 may include the first block 106, the second block 108, a fastener subassembly 110, and a ring 112. The first block 106 may be configured to mechanically interface with the ring 112. The second block 108 may also be configured to mechanically interface with the ring 112. The mechanical interfaces between the ring 112, the first block 106, and the second block 108 enable the first block 106 to be positioned at a particular position relative to the second block 108. Additionally, the mechanical interfaces enable the second block 108 to be repositioned in the particular position following an impact.

The fastener subassembly 110 may be configured to retain the mechanical interfaces between the first block 106, the ring 112, and the second block 108. The fastener subassembly 110 may include a first element 120 and a second element 122. In some embodiments, the first element 120 may include a screw, a bolt, or any other appropriate device for mechanically interfacing with the second element 122. In these and other embodiments, the second element 122 may include a nut or any other appropriate device for mechanically interfacing with the first element 120. The first element 120 may be sized and configured to extend through at least portions of the first block 106, the second block 108, the ring 112, and a spring 130. The first element 120 may mechanically interface with the second element 122 in a fastener volume 136. The spring 130 may apply a spring force on the second block 108 to impose a spring force that increases a force necessary to rotate the second block 108 relative to the first block 106. Some details of each of these components of the vehicle accessory mount assembly 100 are described below.

As discussed above, the arm subassembly 102 may be configured to retain the accessory 104 relative to the vehicle at two or more particular rotational positions and may enable a breakaway feature of the vehicle accessory mount assembly 100. In the present disclosure, reference to “vehicle” may refer to any device or machine that is movable from a first geographic position (e.g., “Point A”) to a second geographic position (e.g., “Point B”). In these or other embodiments, the vehicle may be human-driven, semi-autonomous, or autonomous. Examples of vehicles may include all-terrain vehicles (ATVs), utility task vehicles (UTVs or side-by-sides), dirt bikes, motorcycles, golf carts, watercraft (e.g., boats, personal watercraft, etc.), automobiles, pickups, semi-trucks, robots, drones, equipment (e.g., construction/maintenance equipment such as backhoes, excavators, bulldozers, loaders, etc.), or any other suitable devices. The vehicle may or may not be required to carry a load (e.g., a human rider/driver, a delivery package, a payload, etc.).

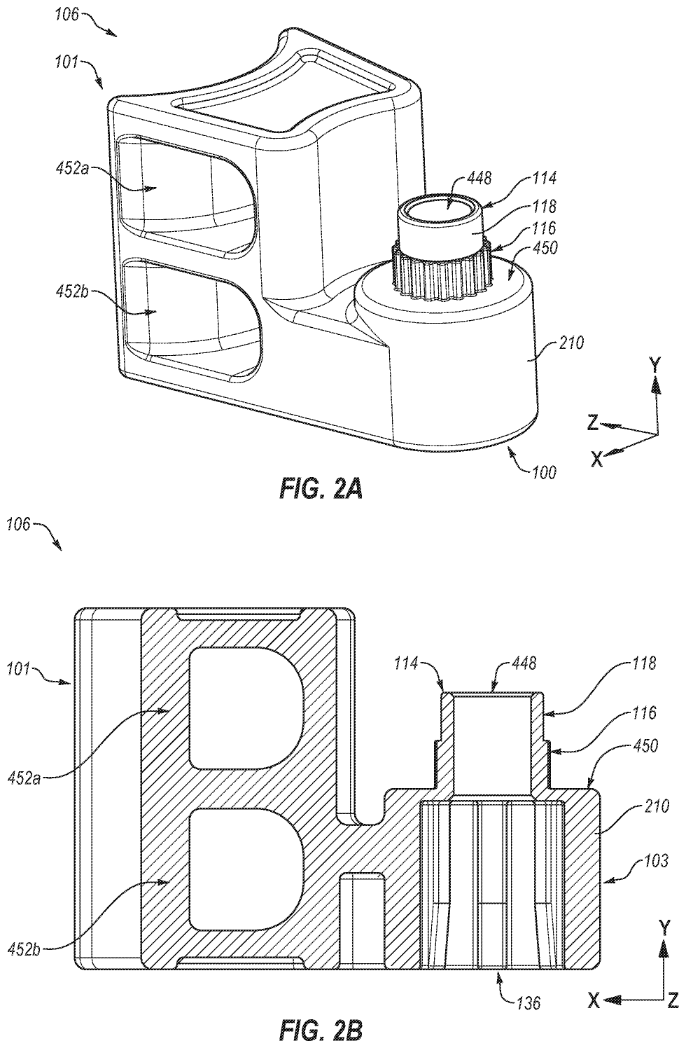

FIGS. 2A and 2B illustrate an example embodiment of the first block 106. The first block 106 may be implemented in the vehicle accessory mount assembly 100 of FIGS. 1A and 1B. FIG. 2A illustrates a perspective view of the first block 106. FIG. 2B illustrates a cross sectional view of the first block 106. The first block 106 is configured to interface with a portion of a vehicle and to interface with a ring (e.g., the ring 112) and a second block (e.g., second block 108).

The first block 106 may include a first end 101. The first end 101 is configured to be placed against or adjacent to a portion of the vehicle. The first block 106 may define a first vehicle interface opening 452a and a second vehicle interface opening 452b (referred to in the present disclosure as vehicle interface openings 452) at the first end 101. With combined reference to FIGS. 1A-2B, the vehicle interface device 124 may be configured to extend through the vehicle interface openings 452. The vehicle interface device 124 may physically attach the first block 106 to the vehicle.

Referring back to FIGS. 2A and 2B, the first block 106 may include a second end 103. The second end 103 may be substantially opposite the first end 101. The second end 103 may include a cylindrical structure 114. The cylindrical structure 114 may generally extend in a first direction (e.g., the Y direction of FIGS. 2A and 2B) from a lower structure 210.

The cylindrical structure 114 may include a second tooth set 116, which may be an example of a first mechanical interlock element. The second tooth set 116 may be disposed on an outer surface 118 of the cylindrical structure 114. In some embodiments, the second tooth set 116 may include a set of longitudinal teeth. For instance, the teeth of the second tooth set 116 may be oriented parallel to the orientation of the cylindrical structure 114. Additionally, the longitudinal teeth may be positioned at a particular rotational interval from one another. The particular rotational interval may be between about three degrees and about thirteen degrees.

The first block 106 may define a first fastener opening 448 and a fastener volume 136. The first fastener opening 448 may be positioned generally on the cylindrical structure 114 and the fastener volume 136 may be defined in the lower structure 210. With reference to FIGS. 2B and 1B, the fastener volume 136 may be configured to receive and retain a second element 122 of the fastener subassembly 110. The first fastener opening 448 may be defined such that a first element 120 of the fastener subassembly 110 may extend through the first fastener opening 448 and mechanically interface with the second element 122 within the fastener volume 136.

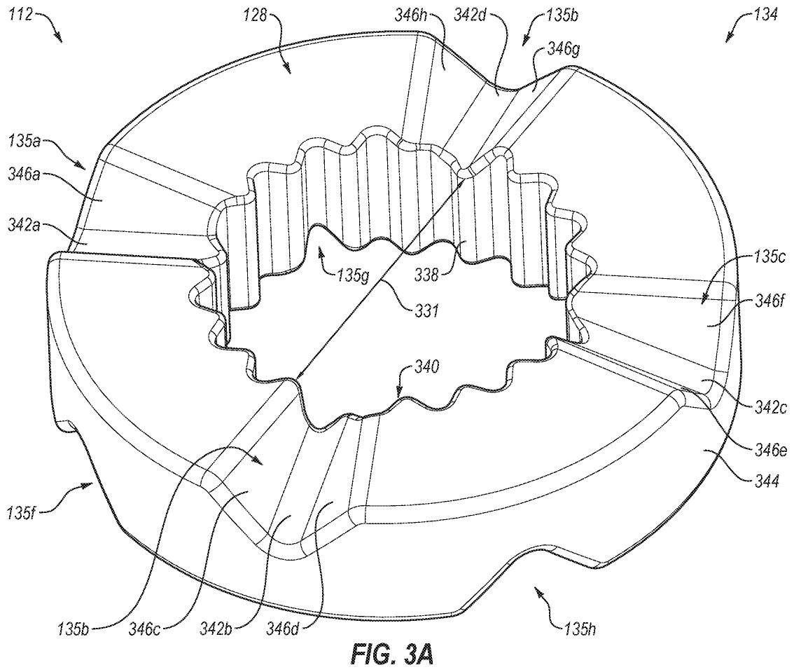

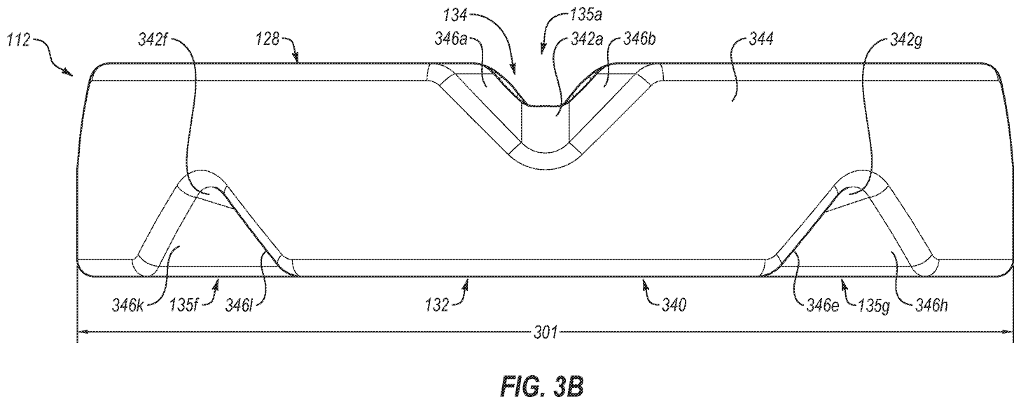

FIGS. 3A and 3B illustrate an example embodiment of the ring 112. The ring 112 of FIGS. 3A and 3B may be implemented in the vehicle accessory mount assembly 100 of FIGS. 1A and 1B, for instance. FIG. 3A illustrates a top perspective view of the ring 112. FIG. 3B illustrates a side view of the ring 112. Referring to FIGS. 2A-3B, the second tooth set 116 and the cylindrical structure 114 may be sized and configured to receive the ring 112, which enables the ring 112 to be placed on the first block 106 at a particular rotational orientation.

For instance, the first block 106 may include a first block radial surface 450 on at least a part of the lower structure 210. When the arm subassembly 102 is in an assembled state, the first block radial surface 450 may physically contact a third radial surface 132 (also shown in FIG. 1B) of the ring 112. The ring 112 may also include an inner circumferential surface 338 that includes a first tooth set 340 (e.g., a third mechanical interlock element). The first tooth set 340 is disposed on the inner circumferential surface 338 of the ring 112. The first tooth set 340 may be sized and configured to mechanically interface with the second tooth set 116 of the first block 106. Additionally, the second tooth set 116 and the first tooth set 340 may be configured to retain a rotational position of the ring 112 relative to the first block 106. In particular, when the ring 112 is placed on the cylindrical structure 114 of the first block 106, the first tooth set 340 may be slid (e.g., translated in the y-direction) onto the cylindrical structure 114. As the ring 112 is slid onto the cylindrical structure 114, the first tooth set 340 may be engaged with the second tooth set 116. Engagement between the first tooth set 340 and the second tooth set 116 may orient the ring 112 relative to the first block 106. Some additional details of components of the ring 112 are included below.

In some embodiments, the first tooth set 340 may include multiple longitudinal teeth that are correspondingly shaped and positioned to the longitudinal teeth of the second tooth set 116. For example, a rotational interval between the longitudinal teeth of the second tooth set 116 and the first tooth set 340 may be the same or substantially the same to enable engagement therebetween.

The ring 112 may include a first radial surface 128 and a third radial surface 132. The third radial surface 132 may be opposite the first radial surface 128. In addition, the ring 112 may include a fourth mechanical interlock element 134. The fourth mechanical interlock element 134 may be disposed on or defined by one or more surfaces of the ring 112. For example, the fourth mechanical interlock element 134 may include a first recess 135a, a second recess 135b, a third recess 135c, a fourth recess 135d disposed on or defined by the first radial surface 128. Additionally the fourth mechanical interlock element 134 may include a fifth recess 135e, a sixth recess 135f, a seventh recess 135g, and an eighth recess 135h disposed on or defined by the third radial surface 132. In the present disclosure, the first—eighth recesses 135a-135h may be generally referred to as a recess 135 or recesses 135.

In the embodiment of FIGS. 3A and 3B, the fourth mechanical interlock element 134 may include eight recesses 135 and the recesses 135 may be positioned at substantially ninety-degree intervals on the first radial surface 128 and/or the third radial surface 132. In other embodiments, the fourth mechanical interlock element 134 may include more than or less than eight recesses 135 that may be positioned at another suitable rotational interval. For instance, in some embodiments, the fourth mechanical interlock element 134 may include six recesses 135, three of the six recesses 135 on each of the first and the third radial surfaces 128 and 132. The three recesses 135 may be separated by 120 degree intervals. Of course other configurations are encompassed by this disclosure. For instance, the ring 112 may include four, six, eight, ten, or another suitable number of recesses 135. Additionally or alternatively, the recesses 135 may be separated by various rotational intervals such as 25 degrees, 30 degrees, 45 degrees, 60 degrees, 80 degrees, or another suitable rotational interval.

The recesses 135 may include angled end surfaces 342 and sloped surfaces 346. For example, the first recess 135a may include a first angled end surface 342a, a first sloped surface 346a, and a second sloped surface 346b (shown in FIG. 3B). The second recess 135b may include a second angled end surface 342b, a third sloped surface 346c, and a fourth sloped surface 346d. Likewise, the third recess 135c may include a third angled end surface 342c, a fifth sloped surface 346e, and a sixth sloped surface 346f In addition, the fourth recess 135d may include a fourth angled end surface 342d, a seventh sloped surface 346g, and an eighth sloped surface 346h. Furthermore, the fifth recess 135e (not shown) may include a fifth angled end surface 342e (not shown), a ninth sloped surface 346i (not shown), and a tenth sloped surface 346j (not shown). The sixth recess 135f may include a sixth angled end surface 342f, an eleventh sloped surface 346k, and a twelfth sloped surface 346l. The seventh recess 135g may include a seventh angled end surface 342g, a thirteenth sloped surface 346m, and a fourteenth sloped surface 346n. The eighth recess 135h (not shown) may include an eighth angled end surface 342h (not shown), a fifteenth sloped surface 346o (not shown), and a sixteenth sloped surface 346p (not shown).

Each of the angled end surfaces 342 may be sloped in a radial direction from the inner circumferential surface 338 to an outer circumferential surface 344. In addition, each of the sloped surfaces 346 may extend from the first radial surface 128 to the corresponding angled end surfaces 342. The angled end surfaces 342 and the sloped surfaces 346 may be sized, shaped, and configured to retain the second block 108 in the initial position or the secondary position until the first force or the second force are applied to the second block 108 or the accessory 104. In some embodiments, the ring 112 may define one or more keys (not shown) that are configured to align the ring 112 in one or more particular rotational positions relative to the cylindrical structure 114.

The first block 106 and/or the ring 112 may be rigid or substantially rigid. Accordingly, the first block 106 and/or the ring 112 may be comprised of any suitable material that may provide a rigid or substantially rigid structure. For instance, the second block 108 may be comprised of aluminum, an aluminum alloy, a rigid plastic (e.g., polypropylene, rigid polyvinyl chloride (PVC), a rigid polyethylene, acetal (POM), etc.), a ceramic material, or combinations thereof.

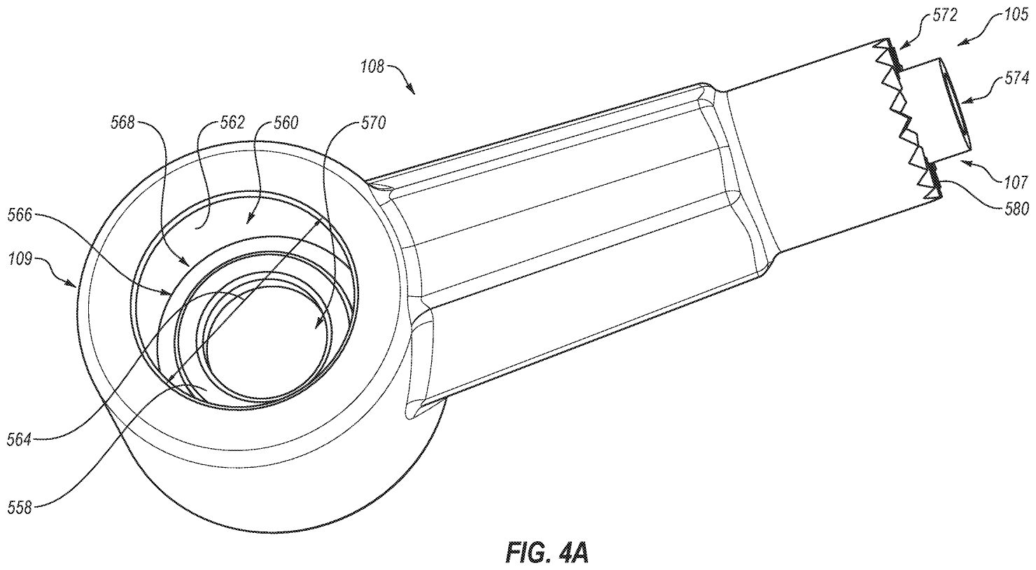

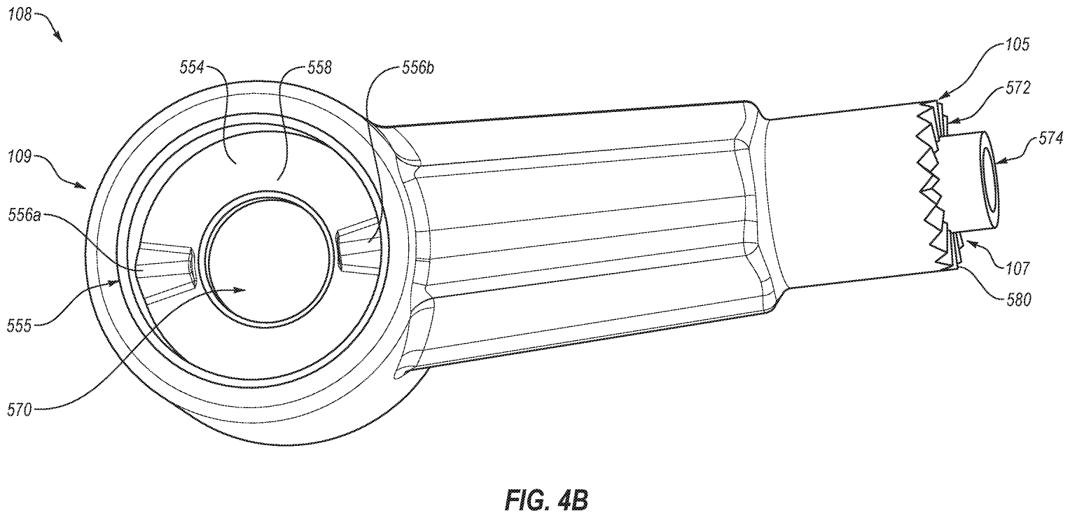

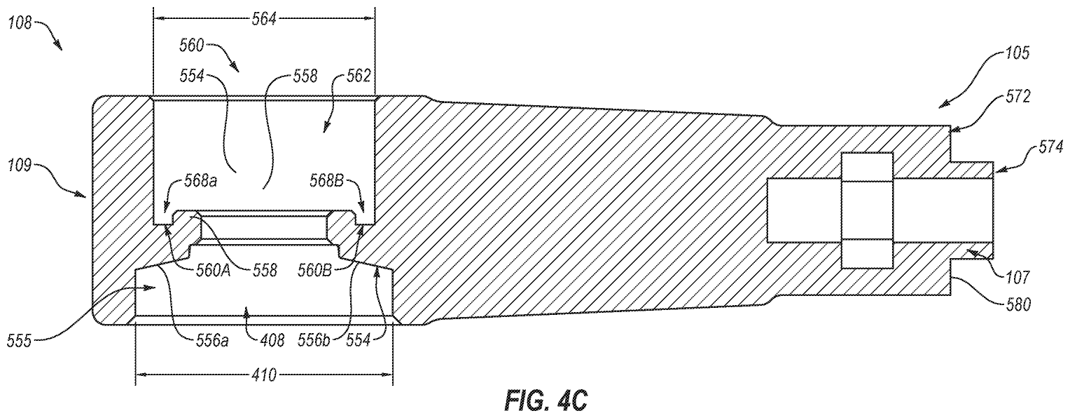

FIGS. 4A-4C illustrate an exemplary embodiment of the second block 108, which may be implemented in the vehicle accessory mount assembly 100 of FIGS. 1A and 1B. FIG. 4A illustrates a top perspective view of the second block 108. FIG. 4B illustrates a bottom perspective view of the second block 108. FIG. 4C illustrates a sectional view of the second block 108. The second block 108 may be configured to rotate relative to the first block 106 described in FIGS. 2A and 2B. The second block 108 may be located farther from a vehicle and may be positioned between an accessory (e.g., 104) and the first block 106.

The second block 108 may be rigid or substantially rigid. Accordingly, the second block may be configured to support and retain the accessory at a particular position relative to the vehicle. The second block 108 may be comprised of any suitable material that may provide a rigid or substantially rigid structure. For instance, the second block 108 may be comprised of aluminum, an aluminum alloy, a rigid plastic (e.g., polypropylene, rigid polyvinyl chloride (PVC), a rigid polyethylene, acetal (POM), etc.), a ceramic material, or combinations thereof.

The second block 108 may include a third end 105 that includes an accessory interface 107. The accessory interface 107 may include a structure or set of structures that are configured to retain an accessory. The accessory interface 107 may further enable a user to position the accessory relative to the remaining portions of the second block 108.

In the embodiment of FIGS. 4A-4C, the accessory interface 107 may include a fifth mechanical interlock element 572. The fifth mechanical interlock element 572 includes a set of longitudinal teeth 580 positioned radially around the third end 105. The set of longitudinal teeth 580 are configured to mechanically interface with a corresponding structure of an accessory such as the accessory 104, an accessory fastener 126 (depicted in FIGS. 1A and 1B) interfaced with the accessory 104, or both. For example, with reference to FIGS. 1A, 1B, and 4A-4C, the accessory 104 and/or the accessory fastener 126 may include a set of corresponding longitudinal teeth configured to prevent the accessory 104 from rotating relative to the second block 108 when suitably engaged. The accessory fastener 126 may extend through a portion of the second block 108 via an accessory opening 574 defined by the second block 108 at the third end 105. Additionally, the second block 108 may include an accessory fastener element 576 (shown in FIG. 4C). The accessory fastener element 576 is configured to mechanically interface with the accessory fastener 126 within the accessory opening 574. In the depicted embodiment, the accessory fastener 126 may include a threaded fastener such as a screw or bolt. The accessory fastener element 576 may include a threaded nut that is positioned within the third end 105. The threaded nut retains the accessory fastener 126 via a threaded connection. In other embodiments, the accessory fastener element and the accessory fastener 126 may include another type of fastener.

The second block 108 also includes a fourth end 109 that is positioned opposite the third end 105. On the fourth end 109, the second block 108 may also define a cylindrical cavity 560. The cylindrical cavity 560 may include a cylindrical or substantially cylindrical shape. An inner ring 558 may extend into the cylindrical cavity 560 from a circumferential surface 562 of the cylindrical cavity 560. The inner ring 558 may define a second block fastener opening 570. The second block fastener opening 570 may be sized and configured to permit the first element 120 of the fastener subassembly 110 to extend through the second block 108.

The fourth end 109 may include a second mechanical interlock element 555. The second mechanical interlock element 555 may be disposed on a second radial surface 554 of the inner ring 558. In the assembled state, the second radial surface 554 may physically contact one of the first radial surface 128 or the third radial surface 132 of the ring 112. For instance, with reference to FIGS. 3A-4C, the ring 112 may be placed in the cylindrical cavity 560 such that the second radial surface 554 is in contact with the first radial surface or the third radial surface 132 of the ring 112. Placement of the ring 112 in the cylindrical cavity 560 may enable the fourth mechanical interlock element 134 to mechanically interface with the second mechanical interlock element 555. Engagement between the fourth mechanical interlock element 134 and the second mechanical interlock element 555 may prevent the second block 108 from rotating relative to the ring 112. Additionally, in the assembled state, the ring 112 may be placed on the cylindrical structure 114 as described above. Accordingly, in the assembled state, the first block 106 may be retained relative to the ring 112 and the ring 112 may be retained relative to the second block 108.

The second mechanical interlock element 555 may include one or more protrusions 556 (shown in FIGS. 4B and 4C). The second mechanical interlock element 555 may include two protrusions 556. The two protrusions 556 may include a first protrusion 556a and a second protrusion 556b (referred to in the present disclosure as protrusions 556). A size and position of the protrusions 556 may correspond to a size and position of the recesses 135 of the ring 112. For example, the size and position of the protrusions 556 may permit the protrusions 556 to mechanically interface with the recesses 135. In addition, the protrusions 556 may include one or more surfaces configured to physically contact the angled end surfaces 342 or the sloped surfaces 346.

In the depicted embodiment, the protrusions 556 may be positioned at substantially one hundred eighty (180) degree intervals on the second radial surface 554. In some embodiments, the protrusions 556 may be positioned at different intervals, for instance, forty-five (45) degree, ninety (90) degree, or two hundred seventy (270) degree intervals.

Referring to FIGS. 1B and 4C, the fastener subassembly 110 may include the spring 130. The spring 130 may be sized and configured to be placed between the inner ring 558 and the circumferential surface 562 of the second block 108. The spring 130 may be configured to apply the spring force when the arm subassembly 102 is in the assembled state. The spring force may retain the mechanical interface between the fourth mechanical interlock element 134 and the second mechanical interlock element 555.

Referring to FIG. 4C, the second block 108 includes a lower cavity 408. The lower cavity 408 may include the protrusions 556. The lower cavity 408 may be sized and configured to receive a ring such as the ring 112. For example, with reference to FIGS. 3B and 4C, a diameter 410 of the lower cavity 408 may correspond to an outer diameter 301 of the ring 112. In some embodiments, the diameter 410 may be substantially equivalent to the outer diameter 301 of the ring 112. In other embodiments, the diameter 410 may be about 5-10% or another suitable portion greater than the outer diameter 301 such that the ring 112 fits into the lower cavity 408.

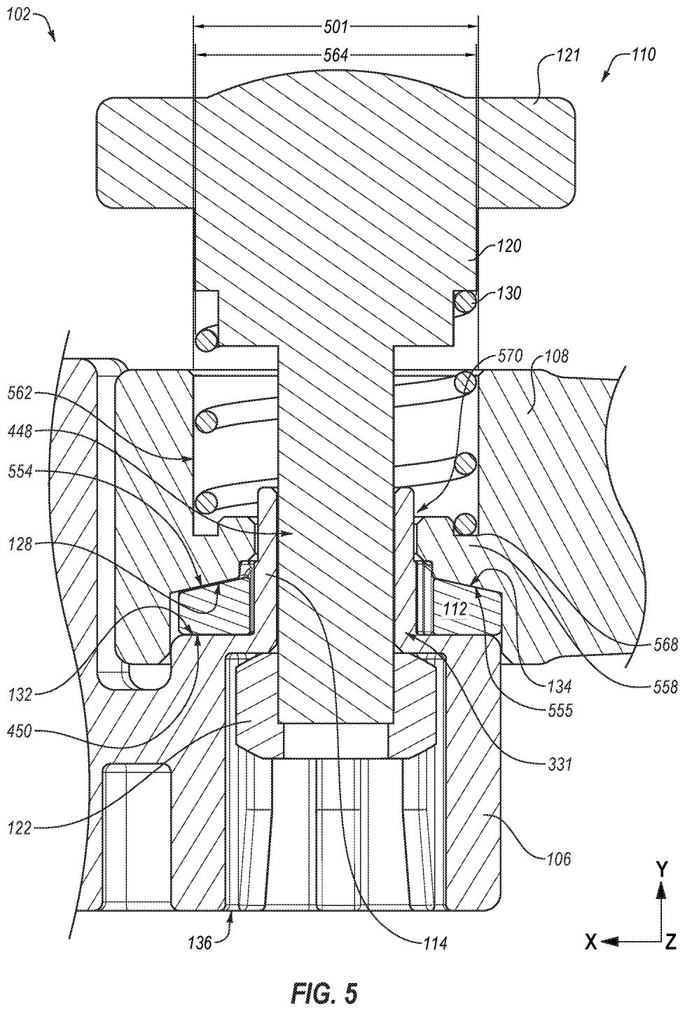

FIG. 5 illustrates a sectional view of a portion the arm subassembly 102 in an assembled state. In the assembled state, the first block 106, the ring 112, and the second block 108 are retained relative to one another by the fastener subassembly 110.

For instance, the spring 130 may be disposed between a head 121 of the first element 120 of the fastener subassembly 110 and the second radial surface 554 of the inner ring 558. In some embodiments, for example, a lower portion of the spring 130 may be disposed within a cylindrical depression 568 defined by the second radial surface 554 and the circumferential surface 562. In the embodiment of FIG. 5, an aperture diameter 564 of a cylindrical cavity 560 may substantially correspond to a spring diameter 501 of the spring 130. For instance, a circumferential surface 562 may contact or be adjacent to an outer edge or surface of the spring 130.

A portion of the cylindrical structure 114 may extend through a portion of the second block 108 via the second block fastener opening 570. Additionally, the first element 120 of the fastener subassembly 110 may extend through the spring 130, the first block 106, the ring 112, and the second block 108 to mechanically interface with the second element 122 within the fastener volume 136. The first element 120 may extend through the second block 108 via the second block fastener opening 570. Likewise, the first element 120 may extend through the first block 106 via the first fastener opening 448. Furthermore, the first element 120 may extend through the ring 112 via a ring opening 331 positioned in a center of the ring 112.

The first block radial surface 450 may physically contact the third radial surface 132 of the ring 112. Additionally, the second radial surface 554 of the second block 108 may physically contact the first radial surface 128 of the ring 112. Additionally, the fourth mechanical interlock element 134 may mechanically interface with the second mechanical interlock element 555.

The head 121 of the first element 120 of the fastener subassembly 110 may apply a force on the spring 130, which compresses the spring 130 between the head 121 of the first element 120 and the second surface 566 of the inner ring 558. The compression of the spring 130 biases the fourth mechanical interlock element 134 interfaced with the second mechanical interlock element 555. For instance, to rotate the ring 112 relative to the second block 108, the protrusions 556 may have to disengage from the recesses 135 in the ring 112. To disengage the protrusions 556 from the recesses 135, the spring 130 may be further compressed. Accordingly, to disengage the protrusions 556 from the recesses 135 involve application of a force sufficient to further compress the spring 130. Furthermore, the compression of the spring 130 may store energy such that when the protrusions 556 are aligned with the recesses 135, the spring 130 extends and presses the protrusions 556 into the recesses 135.

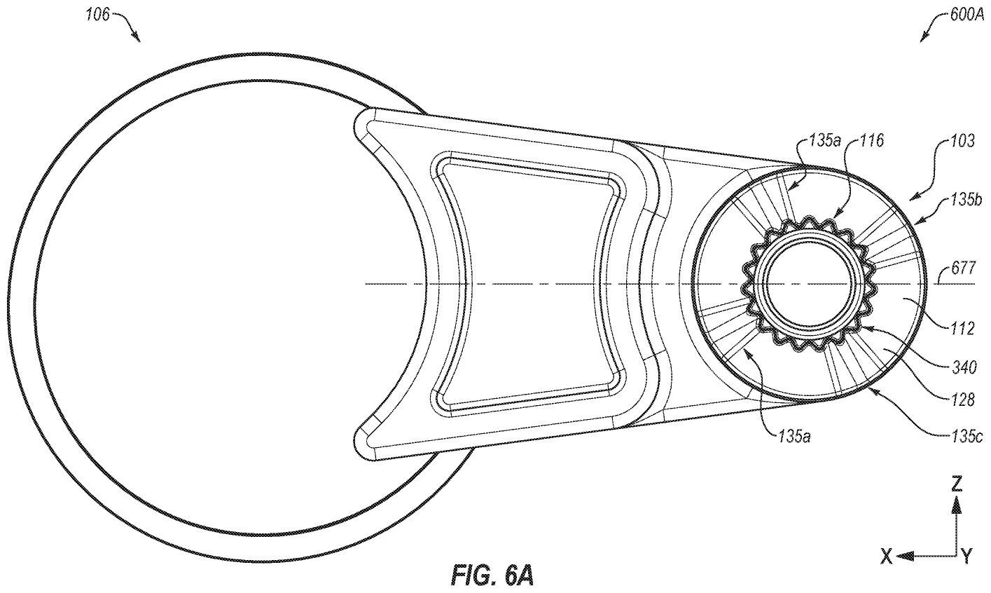

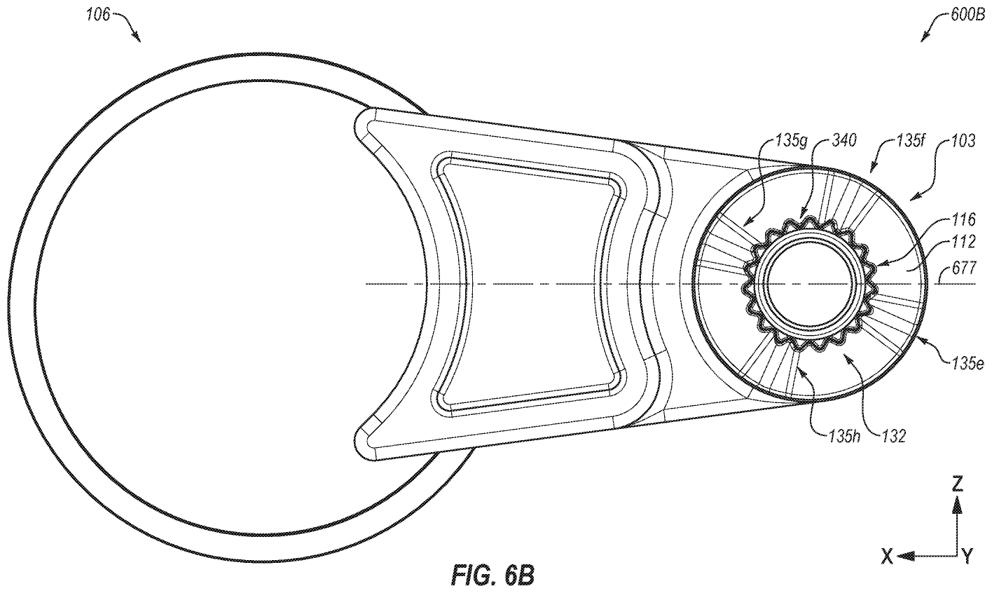

FIGS. 6A and 6B illustrate the exemplary mechanical interfaces between the first block 106 and the ring 112 of the vehicle accessory mount assembly 100 of FIGS. 1A and 1B. FIG. 6A depicts the ring 112 in a first configuration 600A. FIG. 6B depicts the ring 112 in a second configuration 600B.

In the first configuration 600A, the first radial surface 128 is positioned opposite the first block 106 (e.g., facing up or away from the first block 106). Additionally, in the first configuration 600A, the third radial surface 132 may physically contact or be placed immediately adjacent to the first block 106 (e.g., facing down or towards the first block 106). In the second configuration 600B, the third radial surface 132 of the ring 112 is positioned opposite the first block 106 (e.g., facing up or away from the first block 106) and the first radial surface 128 of the ring 112 may physically contact or be placed immediately adjacent to the first block 106 (e.g., facing down or towards the first block 106). To transition between the first configuration 600A and the second configuration 600B, the ring 112 may be flipped (e.g., rotated 180° about an axis parallel to the z axis or x axis) relative to the first block 106.

In addition, the ring 112 may be positioned at different rotational positions relative to the cylindrical structure 114. The ring 112 may be placed at rotational increments relative to the cylindrical structure 114. A distance between the rotational increments is based on the rotational distance between the teeth of the second tooth set 116 and/or the first tooth set 340. For example, in the embodiment of FIGS. 6A and 6B, the increments may be between about 2 degrees and about 12 degrees.

In FIG. 6A, the ring 112 is depicted in the first configuration 600A and a first rotational position relative to the cylindrical structure 114. In FIG. 6A, the first recess 135a may be offset by about sixty degrees from a center line 677 of the first block 106. The second recess 135b may be offset by about negative thirty degrees from the center line 677, the third recess 135c may be offset by about sixty degrees, and the fourth recess 135d may be offset by about negative thirty degrees from the center line 677.

In FIG. 6B, the ring 112 is depicted in the second configuration 600B and the first rotational position relative to the cylindrical structure 114. In FIG. 6B, the fifth recess 135e may be offset by about fifteen degrees from the center line 677, the sixth recess 135f may be offset by about negative seventy five degrees from the center line 677, the seventh recess 135g may be offset by about fifteen degrees from the center line 677, and the eighth recess 135h may be offset by about negative seventy five degrees from the center line 677. The difference in the rotational positions of the recesses 135a-135g between the first configuration 600A and the second configuration 600B illustrate rotational offsets between the first recess—fourth recess 135a-135d on the first radial surface 128 relative to the fifth recess—eighth recess 135e-135g on the third radial surface 132. In the embodiment of FIGS. 6A and 6B, the rotational offsets between the recesses 135a-135g may be between about 8 degrees and about 30 degrees, between about 12 and about 24 degrees, or about 15 degrees.

Accordingly, the positions of the recesses 135a-135g may be changed by removing the ring 112 from the cylindrical structure 114 (e.g., moving the ring 112 in the y-direction relative to the cylindrical structure 114), rotating the ring 112 about an axis parallel to the y-axis and then replacing the ring 112 on the cylindrical structure 114. In addition, the positions of the recesses 135a-135g may be changed by flipping the ring 112 relative to the first block 106. By flipping the ring 112 relative to the first block 106, the recesses 135 may be shifted by about 15 degrees due to the offset between the first—fourth recesses 135a-135d on the first radial surface 128 relative to the fifth—eighth recesses 135e-135g on the third radial surface 132.

The ring 112 of FIGS. 6A and 6B include eight recesses 135a-135g, four on each of the surfaces 128 and 132. The rotational offset between the recesses 135a-135d on the first radial surface 128 and the recesses 135e-135g on the third radial surface 132 is about 15 degrees. In other embodiments, the ring 112 may include more or less than four recesses 135 on one or both of the surfaces 128 and 132. Additionally, the rotational offset may be greater than 15 degrees (e.g., between 17-30 degrees) or less than 15 degrees (e.g., between about 3 and 13 degrees), which may depend at least partially on the number of recesses on each of the surfaces 128 and 132.

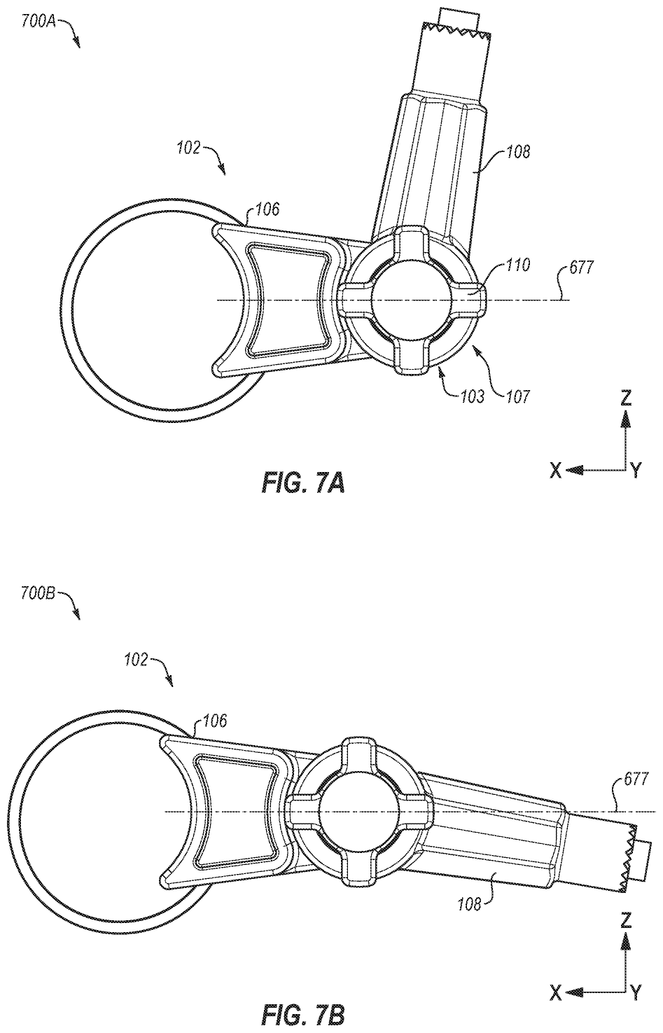

FIGS. 7A and 7B illustrate the arm subassembly 102 in different positions. FIG. 7A illustrates the arm subassembly 102 in an example initial position 700A. FIG. 7B illustrates the arm subassembly 102 in an example secondary position 700B. The transition between the initial position 700A and the secondary position 700B and back provides a “breakaway” feature of the arm subassembly 102. The initial position 700A of FIG. 7A may be set by a user. For instance, one or more of the components (e.g., the ring 112, the first block 106, the second block 108, etc.) of the arm subassembly 102 may be assembled such that the arm subassembly 102 in the initial position. For instance, when the arm subassembly 102 is in the initial position 700A, the protrusions 556 may be engaged with or received in a first set of the recesses 135. The user may set the arm subassembly 102 to orient and/or position an accessory relative to a vehicle. For instance, the user may position the arm subassembly 102 in the initial position 700A to place a mirror at a particular position.

In the embodiment of FIG. 7A, the second block 108 is rotationally offset from the first block 106. For instance, FIG. 7A depicts a center line 677 of the second block 108 to be offset by about negative seventy degrees from the center line 677 of the first block 106. The particular rotational offset is not meant to be limiting.

The arm subassembly 102 may transition to the secondary position 700B responsive to a first force applied to the second block 108 and/or the accessory 104. For instance, the user may drive a vehicle too close to a tree, and may hit the second block 108. Responsive to the impact with the tree, the arm subassembly 102 may transition from the initial position 700A to the secondary position 700B. When the arm subassembly 102 is in the secondary position 700B, the protrusions 556 may be between (e.g., not engaged with or received in) the recesses 135 or the protrusions 556 may be engaged with or received in a second set of the recesses 135.

To transition from the initial position 700A to the secondary position 700B, the first force may have a magnitude that is greater than a particular magnitude. The particular magnitude may be sufficient to overcome the spring force, which may enable movement of the second block 108 relative to the first block 106 when the arm subassembly 102 is in the assembled configuration. In the embodiment of FIG. 7B, in the secondary position 700B, the second block 108 is offset by about twenty degrees from the center line 677 of the first block 106. The particular rotational position of the second block 108 in the secondary position 700B is not meant to be limiting.

The arm subassembly 102 may remain in the secondary position 700B until the user applies a second force to the second block 108 or the accessory 104. For instance, the user may apply a force in an opposite direction to the first force to re-engage the protrusions 556 with the first set of recesses 135. The transition from the initial position 700A to the secondary position 700B and from the secondary position 700B to the initial position 700A provides the “breakaway” features of the arm subassembly 102. For instance, in accessory mounts without the “breakaway” features the first force may damage the accessory or a mount. Instead, in the arm subassembly 102, the first force may simply re-position the accessory without damaging or by minimizing damage to the arm subassembly 102. Moreover, at least a portion of the first force may be absorbed by the spring and the rotational movement of the second block 108. Accordingly, an amount of the force applied to an accessory may be reduced.

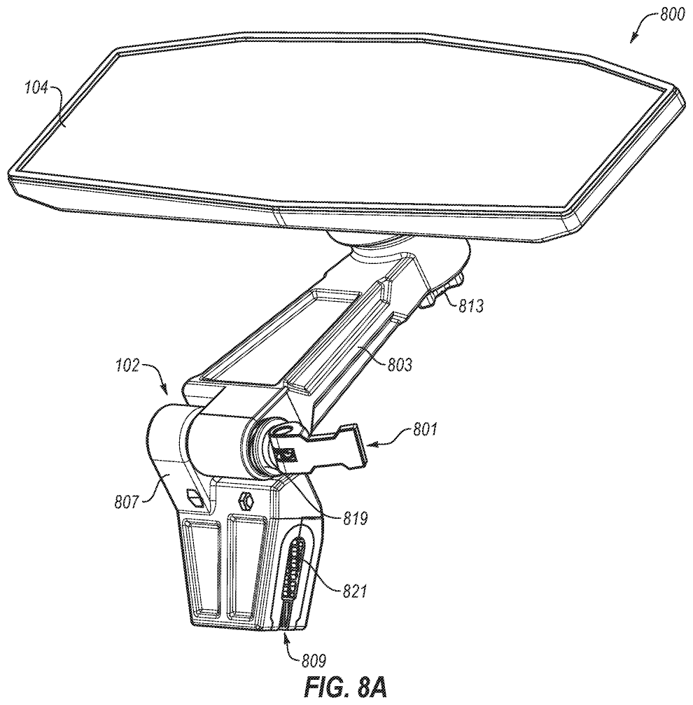

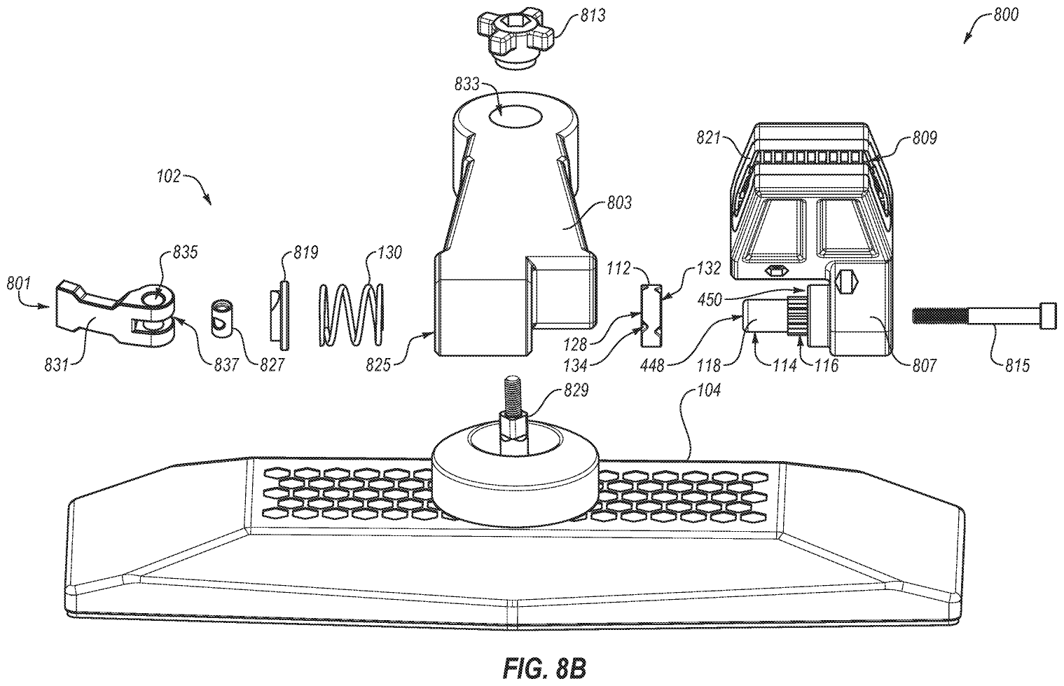

FIGS. 8A and 8B illustrate an additional exemplary vehicle accessory mount assembly 800. FIG. 8A is a perspective view of the additional vehicle accessory mount assembly 800. FIG. 8B is an exploded view of the additional vehicle accessory mount assembly 800. The vehicle accessory mount assembly 800 includes an embodiment of the arm subassembly 102 described above. The arm subassembly 102 may enable a user to place the accessory 104 (shown in FIGS. 8A and 8B as a mirror) at a particular rotational position relative to a vehicle as discussed above.

The arm subassembly 102 of FIGS. 8A and 8B may include a first portion 807 that is configured to be attached to the vehicle via an opening 809 defined by a retention device 821. In some embodiments, a portion of a window of the vehicle such as a boat or watercraft may pass through the opening 809 to physically attach the vehicle accessory mount assembly 800 to the vehicle. The first portion 807 may operate the same as or similar to the first block 106 discussed above. The first portion 807 may include the first block radial surface 450, the outer surface 118, the cylindrical structure 114, the second tooth set 116, and the first fastener opening 448.

The first portion 807 may be placed at a rotational position relative to the vehicle. In addition, the arm subassembly 102 may include a second portion 803 that is configured to be attached to the first portion 807 and to the accessory 104. The second portion 803 may operate the same as or similar to the second block 108 discussed above. The second portion 803 may define a second portion fastener opening 825. The second portion fastener opening 825 may operate the same as or similar to the second block fastener opening 570 discussed above.

The second portion 803 may be placed at an initial position (e.g., a particular rotational position) relative to the first portion 807. The initial position of the first portion 807 orients or places the accessory 104 at the particular rotational position. The second portion 803 may be retained at the initial position until the second portion 803 or the accessory 104 is acted upon by a first force (e.g., via an impact with an environment feature). For instance, the accessory 104 may be positioned to extend substantially normal to the vehicle. As a user operates the vehicle, the accessory 104 may hit an environmental feature. Responsive to the first force being applied by the environmental feature, the second portion 803 and the accessory 104 may rotate a particular rotational distance relative to the first portion 807 to a secondary position. The vehicle accessory mount assembly 800 may enable a re-positioning of the second portion 803 from the secondary position to the initial position.

The accessory 104 may be attached to the second portion 803 using a first fastener element 813 and a second fastener element 829. The first fastener element 813 and the second fastener element 829 may be configured to retain the accessory 104 in a position relative to the second portion 803. The second fastener element 829 may extend through at least a portion of the second portion 803 via an accessory opening 833 defined by the second portion 803. In some embodiments, the second fastener element 829 may mechanically interface with the first fastener element 813 in the accessory opening 833. The first fastener element 813 may apply a force on the second portion 803 and may cause the accessory 104 to apply a force on the second portion 803 to retain the position of the accessory 104 relative to the second portion 803.

The retention device 821 may retain the physical attachment of the first portion 807 to the vehicle. The retention device 821 may include a rubber material or any other appropriate material configured to prevent the first portion 807 from moving relative to the vehicle. For example, the retention device 821 may include a relatively high coefficient of friction, which may increase a force necessary to cause the first portion 807 to move relative to the vehicle.

The arm subassembly 102 may be configured to retain the accessory 104 relative to the vehicle at two or more particular rotational positions and may enable a breakaway feature of the vehicle accessory mount assembly 800. With reference to FIG. 8B, the arm subassembly 102 may include the first portion 807, the second portion 803, a fastener subassembly 801, and the ring 112. The fastener subassembly 801 may operate the same as or similar to the arm subassembly 102 discussed above. In addition, the ring 112 may include the first radial surface 128, the third radial surface 132, and the fourth mechanical interlock element 134.

The first portion 807 may be configured to mechanically interface with the ring 112. The second portion 803 may also be configured to mechanically interface with the ring 112. The mechanical interfaces between the ring 112, the first portion 807, and the second portion 803 enable the first portion 807 to be positioned at a particular position relative to the second portion 803. Additionally, the mechanical interfaces enable the second portion 803 to be repositioned in the particular position following an impact.

The fastener subassembly 801 may be configured to retain the mechanical interfaces between the first portion 807, the ring 112, and the second portion 803. The fastener subassembly 801 may include a first element 831, a second element 827, a third element 819, and a fourth element 815. In some embodiments, the first element 831 may include a push/pull arm configured to mechanically interface with the second element 827 and the third element 819. The second element 827 may be sized and configured to extend through a first opening 835 defined by the first element 831. The second element 827 may also be sized and configured to extend across a second opening 837 defined by the first element 831.

In some embodiments, the fourth element 815 may include a screw, a bolt, or any other appropriate device for mechanically interfacing with the second element 827. In these and other embodiments, the second element 827 may include a nut or any other appropriate device for mechanically interfacing with the first element 831 and the fourth element 815. The fourth element 815 may be sized and configured to extend through at least portions of the first portion 807, the second portion 803, the ring 112, the third element 819, and the spring 130. The spring 130 may apply a spring force on the second portion 803 to impose a spring force that increases a force necessary to rotate the second portion 803 relative to the first portion 807 (e.g., when the first element 831 is in a second rotational position).

The first element 831 may be sized and configured to be positioned at two or more particular rotational positions relative to the second element 827 and the third element 819. For example, rotation of the first element 831 from a first rotational position (illustrated in FIG. 8A) to the second rotational position draws the fourth element 815 in a direction towards the first element 831. In addition, the rotation of the first element 831 from the first rotational position to the second rotational position may move the third element 819 in a direction towards the fourth element 815.

The fourth element 815 being drawn in the direction towards the first element 831 may apply a force on the first portion 807. The force being applied on the first portion 807 may retain the mechanical interface between the first portion 807 and the ring 112. Likewise, the third element 819 being moved in the direction towards the fourth element 815 may cause the spring 130 to apply the spring force on the second portion 803. The spring force being applied on the second portion 803 may retain the mechanical interface between the second portion 803 and the ring 112.

In some embodiments, a portion of the first element 831 that defines the first opening 835 may be relatively thicker (e.g., a thicker portion) than another portion of the first element 831 that defines the first opening 835 (e.g., a thinner portion). The first element 831 may be sized and configured such that when the first element is in the first rotational position, the thinner portion of the first element 831 may be positioned substantially adjacent to the third element 819. In addition, the first element 831 may be sized and configured such that when the first element is in the second rotational position, the thicker portion of the first element 831 may be positioned substantially adjacent the third element 819. Thus, the rotation of the first element 831 from the first rotational position to the second rotational position may increase a distance between the second element 827 and the third element 819. The increased distance may cause the third element to move towards the fourth element 815 and apply a force on the spring 130.

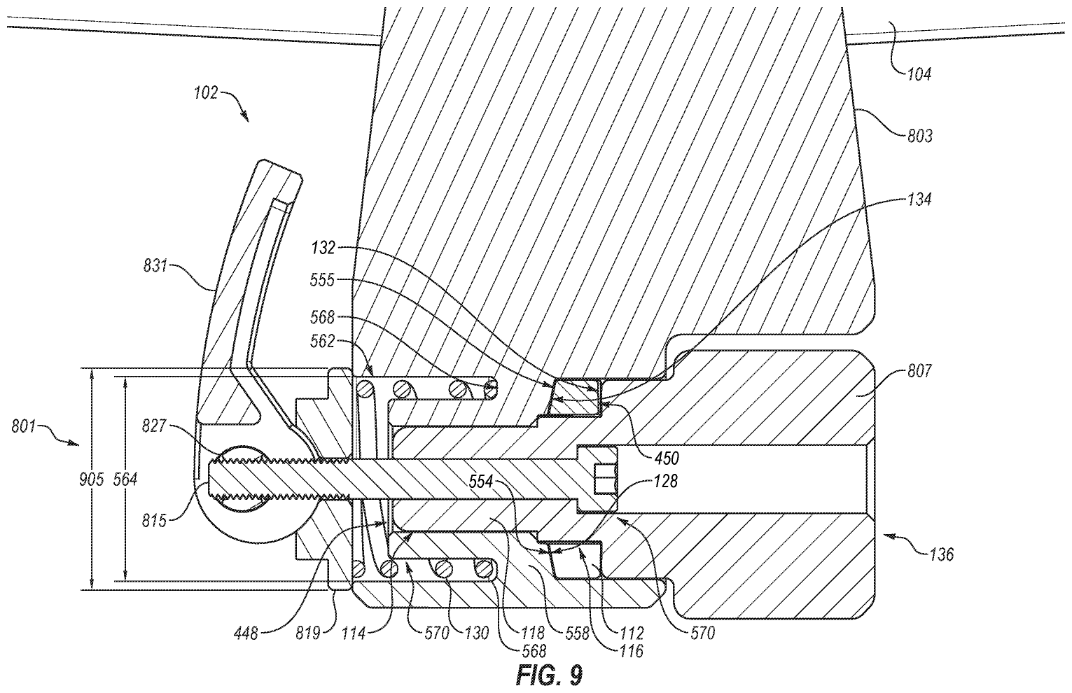

FIG. 9 illustrates a cross sectional view of a portion of the vehicle accessory mount assembly 800 and the exemplary arm subassembly 102 of FIGS. 8A and 8B. FIG. 9 illustrates the cross sectional view of the portion of the arm subassembly 102 in an assembled state. In the assembled state, the first portion 807, the ring 112, and the second portion 803 are retained relative to one another by the fastener subassembly 801.

For instance, the spring 130 may be disposed between the third element 819 and the second radial surface 554 of the inner ring 558. In some embodiments, for example, the lower portion of the spring 130 may be disposed within the cylindrical depression 568 defined by the second radial surface 554 and the circumferential surface 562. In the embodiment of FIG. 9, an aperture diameter 564 of the cylindrical cavity 560 may substantially correspond to a diameter 905 of the third element 819. For instance, the circumferential surface 562 may contact or be adjacent to an outer edge or surface of the spring 130.

A portion of the cylindrical structure 114 may extend through a portion of the second portion 803 via the second block fastener opening 570. Additionally, the fourth element 815 of the fastener subassembly 801 may extend through the spring 130, the first portion 807, the ring 112, and the second portion 803 to mechanically interface with the second element 827 via the fastener volume 136. The first element 120 may extend through the second block 108 via the second block fastener opening 570. Likewise, the first element 120 may extend through the first block 106 via the first fastener opening 448. Furthermore, the first element 120 may extend through the ring 112 via a ring opening 331 positioned in the center of the ring 112.

The first block radial surface 450 may physically contact the third radial surface 132 of the ring 112. Additionally, the second radial surface 554 of the second portion 803 may physically contact the first radial surface 128 of the ring 112. Additionally, the fourth mechanical interlock element 134 may mechanically interface with the second mechanical interlock element 555.

The third element 819 of the fastener subassembly 801 may apply a force on the spring 130, which compresses the spring 130 between the third element 819 and the second surface 566 of the inner ring 558. The compression of the spring 130 biases the fourth mechanical interlock element 134 interfaced with the second mechanical interlock element 555. For instance, to rotate the ring 112 relative to the second block 108, the protrusions 556 may have to disengage from the recesses 135 in the ring 112. To disengage the protrusions 556 from the recesses 135, the spring 130 may be further compressed. Accordingly, to disengage the protrusions 556 from the recesses 135 involve application of a force sufficient to further compress the spring 130. Furthermore, the compression of the spring 130 may store energy such that when the protrusions 556 are aligned with the recesses 135, the spring 130 extends and presses the protrusions 556 into the recesses 135.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Unless otherwise described in the present disclosure with respect to a particular element of the present disclosure, the terms “about,” “approximately,” and “substantially” may be interpreted as within 15% of actual value(s), target value(s), possible value(s), and predicted value(s).

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A breakaway arm subassembly of a vehicle accessory mount assembly, the arm subassembly comprising:
a ring having an inner circumferential surface and a first radial surface;
a first mechanical interlock element on the first radial surface of the ring;
a first tooth set disposed on the inner circumferential surface of the ring;
a first block including a cylindrical structure extending in a first direction;
a second tooth set disposed on an outer surface of the cylindrical structure, the second tooth set and the cylindrical structure being sized and configured to receive the ring such that the first tooth set mechanically interfaces with the second tooth set to retain a rotational position of the ring relative to the first block;
a second block including a second radial surface; and
a second mechanical interlock element disposed on the second radial surface, the second radial surface being sized and configured to contact the first radial surface such that the first mechanical interlock element mechanically interfaces with the second mechanical interlock element.

2. The arm subassembly of claim 1, further comprising:
a fastener subassembly configured to retain the first block relative to the second block; and
a spring sized and configured to be placed between an element of the fastener subassembly and the second block, the spring sized and configured to apply a spring force that acts to retain the first mechanical interlock element mechanically interfaced with the second mechanical interlock element.

3. The arm subassembly of claim 2, wherein:
the fastener subassembly includes a first element and a second element; and
the first element of the fastener subassembly extends through at least portions of the first block, the second block, and the ring and is configured to be assembled with the second element when the first block is assembled with the second block.

4. The arm subassembly of claim 3, wherein the first block includes a fastener volume that is configured to receive and retain the second element of the fastener subassembly.

5. The arm subassembly of claim 2, wherein:
the first mechanical interlock element and the second mechanical interlock element are sized and configured to enable rotation of the second block a particular distance relative to the ring responsive to application of a force to the second block sufficient to overcome the spring force.

6. The arm subassembly of claim 5, wherein:
the first mechanical interlock element and the second mechanical interlock element are sized and configured to enable rotation of the second block a first rotational distance relative to the ring responsive to a first force and to enable rotation of the second block a second rotational distance relative to the ring responsive to a second force;
the first rotational distance is substantially equivalent to the second rotational distance and in an opposite direction; and
the first force is in a direction that is substantially rotationally opposite the second force.

7. The arm subassembly of claim 2, wherein:
the second block defines a substantially cylindrical cavity and includes an inner ring;
the inner ring extends into the cylindrical cavity from a circumferential surface of the cylindrical cavity; and
the second mechanical interlock element is included on a first surface of the inner ring.

8. The arm subassembly of claim 7, wherein:
an aperture diameter of the cylindrical cavity substantially corresponds to a spring diameter of the spring; and
a second surface of the inner ring that is opposite the first surface is configured to receive the spring.

9. The arm subassembly of claim 8, wherein the second surface of the inner ring defines a cylindrical depression that corresponds to the spring diameter configured to receive a portion of the spring.

10. The arm subassembly of claim 1, wherein the first tooth set and the second tooth set include longitudinal teeth configured to enable the ring to be positioned on the cylindrical structure and to substantially prevent rotation of the ring relative to the cylindrical structure.

11. The arm subassembly of claim 1, wherein:
the first mechanical interlock element includes one or more recesses disposed in the first radial surface; and
the second mechanical interlock element includes one or more protrusions having a structure that corresponds to a size and configuration of the recesses.

12. The arm subassembly of claim 11, wherein:
the one or more recesses includes four recesses defined at about 90-degree intervals around the first radial surface; and
the one or more protrusions includes two protrusions defined at about 180-degrees from one another.

13. The arm subassembly of claim 11, wherein:
the ring includes a third radial surface that is opposite the first radial surface;
the first mechanical interlock element includes one or more additional recesses disposed in the third radial surface; and
the one or more additional recesses is rotationally offset from the one or more recesses on the first radial surface.

14. The arm subassembly of claim 11, wherein the one or more recesses includes an angled end surface that is sloped in a radial direction from the inner circumferential surface to an outer circumferential surface and the one or more recesses includes two sloped surfaces that extend from the first radial surface to the angled end surface.

15. An arm subassembly of a vehicle accessory mount assembly comprising:
a first block including a first end having a vehicle interface and a second end having a cylindrical structure that includes a first mechanical interlock element;
a second block including a first end having an accessory interface and a second end having a second mechanical interlock element; and
a ring including a third mechanical interlock element and a fourth mechanical interlock element, wherein:
the first mechanical interlock element is configured to mechanically interface with the third mechanical interlock element to enable the ring to be positioned on the cylindrical structure and to substantially prevent rotation of the ring relative to the cylindrical structure; and
the second mechanical interlock element is configured to mechanically interface with the fourth mechanical interlock element to enable rotation of the second block a particular distance relative to the ring responsive to application of a force to the second block of a particular magnitude.

16. The arm subassembly of claim 15, wherein:
the fourth mechanical interlock element is disposed on a first radial surface of the ring;
the fourth mechanical interlock element includes one or more recesses disposed defined in the first radial surface;
the second mechanical interlock element is disposed on a second radial surface of the second block; and
the second mechanical interlock element includes one or more protrusions having a structure that corresponds to a size and configuration of the one or more recesses.

17. The arm subassembly of claim 16, wherein:
the one or more recesses includes four recesses disposed at about 90-degree intervals around the first radial surface; and
the one or more protrusions includes two protrusions disposed at about 180-degrees from one another.

18. The arm subassembly of claim 17, wherein:
the ring includes a third radial surface that is opposite the first radial surface;
the first mechanical interlock element includes one or more additional recesses disposed on the third radial surface; and
the one or more additional recesses is rotationally offset from the one or more recesses on the first radial surface.

19. The arm subassembly of claim 15, wherein:
the third mechanical interlock element is disposed on an inner circumferential surface of the ring;
the third mechanical interlock element includes a first tooth set comprising a first plurality of longitudinal teeth;
the first mechanical interlock element disposed on an outer surface of the cylindrical structure; and
the first mechanical interlock element includes a second tooth set comprising a second plurality of longitudinal teeth that correspond to the first plurality of longitudinal teeth.

20. The arm subassembly of claim 15, further comprising:
a fastener assembly configured to retain the first block relative to the second block; and
a spring sized and configured to be placed between an element of the fastener assembly and the second block, the spring sized and configured to apply a spring force that acts to retain the first mechanical interlock element mechanically interfaced with the second mechanical interlock element.

21. The arm subassembly of claim 20, wherein the particular magnitude is a force sufficient to overcome the spring force.
